(19) United States
(12) Patent Application Publication
(10) Pub. No.: US 2016/0301729 A1
(43) Pub. Date: Oct. 13, 2016

(54) METHODS AND SYSTEMS FOR PRESENTING VIDEO IN A CONTEXT-SENSITIVE MANNER

(71) Applicant: SMART Technologies ULC

(72) Inventors: Lina Gurevich, Calgary (CA); Douglas Hill, Calgary (CA); Alexander Garin, Calgary (CA); David Lim, Calgary (CA); Raul Nemes, Calgary (CA); Xiaomin Wu, Calgary (CA); Michael Rounding, Calgary (CA); Alan Boykiw, Calgary (CA)

(21) Appl. No.: 14/682,429

(22) Filed: Apr. 9, 2015

(51) Int. Cl. H04L 29/06; H04L 12/24

(52) U.S. Cl. CPC H04L 65/602; H04L 65/403; H04L 41/22

(57) ABSTRACT

A method comprises receiving, by a computing device, a video stream comprising a first presentation interface, separating the received video stream from the first presentation interface, processing the separated video stream, and presenting the processed video stream on a display device in the absence of the first presentation interface.

### FIELD

The subject application relates generally to conferencing systems and in particular, to methods, a system, a non-transitory computer readable medium and an apparatus for presenting video in a context-sensitive manner.

### BACKGROUND

Conferencing systems that allow participants to collaborate from different locations, such as for example, SMART Bridgit™, Microsoft® Live Meeting, Cisco® MeetingPlace, Cisco® WebEx, etc., are known. These conferencing systems typically utilize computing devices such as personal computers, laptop computers, tablet computers etc., telecommunications networks, video cameras and/or recorders, microphones and other peripheral devices to allow meeting participants at various geographical locations to exchange application data, audio and/or video.

For example, SMART Bridgit™ offered by SMART Technologies ULC of Calgary, Alberta, Canada, assignee of the subject application, allows a user to set up a conference session having an assigned conference name and password at a Bridgit™ server. Conference participants at different geographical locations may join the conference session by connecting to the Bridgit™ server via their computing devices and providing the correct conference name and password to the Bridgit™ server. During the conference session, data, audio and video connections are established between the computing devices of the conference participants via the Bridgit™ server. Application data, audio and/or video are then captured by the conferencing system and the captured application data, audio and/or video are transmitted to the computing device of each participant of the conference session. The application data may be handled by a shared whiteboard application executed on a host computer that presents images of a shared workspace to each participant of the conference session. In some instances, it is desirable to permit contributions from conference participants to the shared whiteboard application. This can be done by permitting the host computer running the shared whiteboard application to be controlled by a remote conference participant or by allowing conference participants to send annotations, which are then displayed on the shared workspace, and thus to all conference participants.

Unfortunately, when audio and video are combined with the shared whiteboard application to facilitate collaboration, the video and audio are typically not seamlessly integrated with the shared whiteboard application. The video is usually handled by a video application component of the conferencing system that is provided by a third party (relative to the shared whiteboard application) resulting in the video being displayed within its native user interface at a location determined by the video component. Presenting the video in this manner is often undesired as the video's native user interface including, for example its windows, borders, selectable control buttons and other graphical user interface (GUI) elements, often do not interface well with the user interface of the shared whiteboard application resulting in a less than desirable conferencing experience.

As will be appreciated, improvements in conferencing systems are desired. It is therefore an object to provide novel methods, a system, a non-transitory computer readable medium and an apparatus for presenting video in a context-sensitive manner.

### SUMMARY

Accordingly, in one aspect there is provided a method comprising: receiving, by a computing device, a video stream comprising a first presentation interface; separating the received video stream from the first presentation interface; processing the separated video stream; and presenting the processed video stream on a display device in the absence of said first presentation interface.

The presenting may comprise presenting the video stream on the display device within a second presentation interface. The first presentation interface may be for example the default native presentation interface of a video application component generating the video stream. The second presentation interface may be customized for an interactive surface of the display device. The appearance of the video stream presented within the second presentation interface may be altered by, for example, changing the transparency of the video stream and second presentation interface or by changing the position of the video stream presented within the second presentation interface.

Processing the separated video stream may comprise at least one of rotating frames of the video stream, resizing frames of the video stream, bit-splitting frames of the video stream, interpolating frames of the videos stream, sub-sampling frames of the video stream, flipping frames of the video stream, perspective foreshortening frames of the video stream, relocating frames of the video stream and adjusting the frame rate of the video stream.

According to another aspect there is provided a non-transitory computer readable medium having computer program code stored thereon, the computer program code when executed by one or more processors, causing the one of more processors to: separate a received video stream from a first presentation interface thereof; process the separated video stream; and present the processed video stream on a display device in the absence of said first presentation interface.

According to another aspect there is provided a method comprising: receiving, by a computing device, a plurality of video streams, at least one of said video streams comprising a first presentation interface; separating the at least one video stream from the first presentation interface; processing the separated at least one video stream; and presenting the processed at least one video stream on a display device in the absence of said first presentation interface.

The presenting may comprise presenting a plurality of video streams within a second presentation interface. The video streams may be arranged in one of a horizontal row and a vertical column and may be presented within panels or panes of a video strip.

According to another aspect there is provided an apparatus comprising: at least one display device; memory storing executable code; and one or more processors communicating with said display device and memory, said one or more processors configured to execute said executable code at least to cause said apparatus to: separate a received video stream from a first presentation interface thereof; process the separated video stream; and present the processed video stream on the display device in the absence of said first presentation interface.

### BRIEF DESCRIPTION OF THE DRAWINGS

Embodiments will now be described more fully with reference to the accompanying drawings in which:

FIG. 1 is a schematic representation of a conferencing system comprising a plurality of conference participant locations communicating over a network;

FIG. 2 is a flowchart showing steps of an exemplary method of presenting an incoming video stream on an interactive board;

FIG. 3a is a front elevational view of an interactive board of the conferencing system of FIG. 1 displaying an incoming video stream within its native presentation interface;

FIG. 3b is a representation of the incoming video stream of FIG. 3a separated from its native presentation interface;

FIG. 3c is a front elevational view of the interactive board of FIG. 3a displaying the separated incoming video stream;

FIG. 4 is a flowchart showing steps of an exemplary method of presenting an outgoing video stream on an interactive board;

FIG. 5a is a front elevational view of the interactive board of FIG. 3a displaying an outgoing video stream within its native presentation interface;

FIG. 5b is a representation of the outgoing video stream of FIG. 5a separated from its native presentation interface;

FIG. 5c is a front elevational view of the interactive board of FIG. 5a displaying the separated outgoing video stream within an alternative presentation interface;

FIG. 6a is a front elevational view of the interactive board presenting multiple video streams within a horizontal video strip of an alternative presentation interface;

FIG. 6b is a front elevational view of the interactive board of FIG. 6a showing manipulation of the horizontal video strip;

FIG. 7a is a front elevational view of the interactive board presenting multiple video streams within the horizontal video strip;

FIG. 7b is a front elevational view of the interactive board of FIG. 7a showing manipulation of the horizontal video strip;

FIG. 8a is a front elevational view of the interactive board presenting multiple video streams within the horizontal video strip;

FIG. 8b is a front elevational view of the interactive board of FIG. 8a showing manipulation of the horizontal video strip;

FIG. 9 is a front elevational view of the interactive board presenting multiple video streams within a vertical video strip;

FIG. 10a is a front elevational view of the interactive board presenting a video stream;

FIG. 10b is a front elevational view of the interactive board of FIG. 10a presenting the video stream in a different location;

FIG. 11a is a front elevational view of an alternative interactive board comprising a proximity detector;

FIG. 11b is a front elevational view of the interactive board of FIG. 11a together with a conference participant detected by the proximity detector; and

FIG. 12 is a schematic representation of another embodiment of a conferencing system.

### DETAILED DESCRIPTION OF EMBODIMENTS

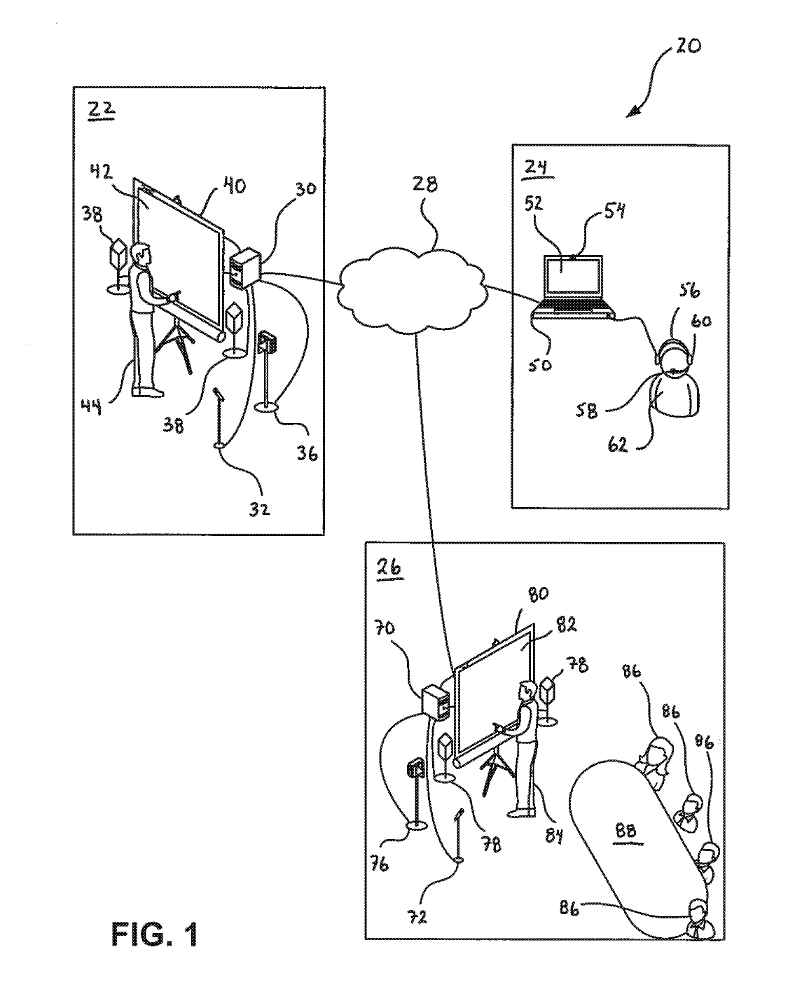

Turning now to FIG. 1, a conferencing system is shown and is generally identified by reference numeral 20. As can be seen, conferencing system 20 comprises a plurality of conference sites or participant locations, namely a local site 22 and remote sites 24 and 26 that communicate with each other over a network 28 during a conference session. The network 28 may be for example a local area network (LAN) or Intranet within an organization, a wide area network (WAN), a cellular network, the Internet or a combination of different networks. Although only two remote sites 24 and 26 are shown, those of skill in the art will appreciate that this is for ease of illustration only. During the conference session, only one remote site or more than two remote sites may communicate with the local site 22 over the network 28.

In this embodiment, local site 22 comprises a computing device 30 such as a server that communicates with the network 28 over a suitable wired, wireless or combined wired/wireless connection. The computing device 30 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.) and a system bus coupling the various components to the processing unit. A plurality of external peripheral devices are connected to the computing device 30 via suitable wired or wireless connections. In particular, a microphone 32, a video camera 36, speakers 38, and an interactive board (IB) 40 having an interactive surface 42 on which images are displayed, are connected to the computing device 30. A participant or conferee 44 is shown standing in front of the interactive surface 42 of the interactive board 40.

The interactive board 40 in this embodiment employs for example, analog resistive or machine vision technology to detect pointer interaction with the interactive surface 42 allowing pointer activity proximate the interactive surface 42 to be recorded and displayed as writing or drawing or used to control execution of one or more application programs running on the computing device 30. Interactive boards of this nature are sold by SMART Technologies ULC under the names SMART Board® 4000, SMART Board® 6000, SMART Board® M600, and SMART Board® 800 for example. The microphone 32 and video camera 36 are oriented and positioned at physical locations within the local site 20 suitable to capture audio and video during the conference session. Although the microphone 32, video camera 36 and speakers 38 are shown as being separate stand-alone components, those of skill in the art will appreciate that the microphone 32, video camera 36 and/or speakers 38 may be integrated into one or more devices. For example, the microphone 32, video camera 36 and/or speakers 38 may be integrated into the interactive board 40.

Remote site 24 comprises a computing device 50 such as a laptop computer having an integrated display screen 52, video camera 54, microphone (not shown) and speakers (not shown). The computing device 50 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.), input/output devices (e.g. a mouse, a keyboard, one or more buttons etc.), and a system bus coupling the various components to the processing unit. Computing device 50 communicates with the network 28 over a suitable wired, wireless or combined wired/wireless connection. In this example, only one external peripheral is connected to the computing device 50 via a suitable wired or wireless connection, namely a headset 56 comprising a microphone 58 and speakers 60. A participant or conferee 62 is shown wearing the headset 56. As is well known in the art, when the headset 56 is connected to the computing device 50, the microphone 58 and speakers 60 of the headset 56 are enabled and the integrated microphone and speakers of the computing device 50 are disabled.

Remote site 26 is similar to the local site 22 and comprises a computing device 70 such as a server that communicates with the network 28 over a suitable wired, wireless or combined wired/wireless network connection. The computing device 70 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.), input/output devices (e.g. a mouse, a keyboard, one or more buttons etc.), and a system bus coupling the various components to the processing unit. A plurality of external peripheral devices are connected to the computing device 70 via suitable wired or wireless connections. In particular, a microphone 72, a video camera 76, speakers 78 and an interactive board 80 having an interactive surface 82 on which images are displayed, are connected to the computing device 70. One participant or conferee 84 is shown standing in front of the interactive surface 82 of the interactive board 80 while other participants or conferees 86 are shown seated around a conference table 88.

Similar to interactive board 40, interactive board 80 also employs, for example, analog resistive or machine vision technology to detect pointer interaction with the interactive surface 82 allowing pointer activity proximate the interactive surface 82 to be recorded and displayed as writing or drawing or used to control execution of one or more application programs running on the computing device 70. The microphone 72 and video camera 76 are oriented and positioned at physical locations within the remote site 26 suitable to capture audio and video during the conference session. Although the microphone 72, video camera 76 and speakers 78 are shown as being separate stand-alone components, those of skill in the art will appreciate that the microphone 72, video camera 76 and/or speakers 78 may be integrated into one or more devices. For example, the microphone 72, video camera 76 and/or speakers 78 may be integrated into the interactive board 80.

Each computing device 30, 50 and 70 runs a host conferencing application allowing the computing devices to share audio, video and data during a conference session. In the case of computing device 30, the host application comprises an interactive board application component that interfaces with the interactive board 40, a video application component that handles the video stream generated in response to video captured by the video camera 36 and that handles incoming video streams generated in response to video captured by the video cameras 54 and 76, an audio application component that handles audio picked up by the microphone 32 and that handles incoming audio streams generated in response to audio picked up by the microphones 58 and 72, and a data conferencing application component that transmits and receives data such as images and annotations to be displayed on the interactive boards 40 and 80 and the display screen 52.

As mentioned previously, vendors of video application components are typically different than vendors of interactive board application components. Although vendors of video application components provide the video application components with software development kits (SDKs) and/or application programming interfaces (APIs) to allow the video application components to be integrated into host conferencing applications, the SDKs and APIs do not have the required functions and interfaces that allow the video streams handled by the video application components to be separated from their default native presentation or user interfaces. As mentioned previously, the default native presentation or user interfaces of the video application components often do not integrate well with the presentation interfaces of the interactive board application components. In this embodiment, the video application component is Lync™ 2010 provided by Microsoft Corporation of Redwood, Washington, U.S.A. and the interactive board application component is provided by SMART Technologies ULC. To enhance the manner by which video streams are presented on the interactive surface 42 of the interactive board 40, the host conferencing application running on the computing device 30 also comprises a video interface application component as will described.

In the case of computing device 70, the host conferencing application comprises an interactive board application component that interfaces with the interactive board 80, a video application component that handles the video stream generated in response to video captured by the video camera 76 and that handles incoming video streams generated in response to video captured by the video cameras 36 and 54, an audio application component that handles audio picked up by the microphone 72 and that handles incoming audio streams generated in response to audio picked up by the microphones 32 and 58, and a data conferencing application component that transmits and receives data such as images and annotations to be displayed on the interactive boards 40 and 80 and the display screen 52. Similar to computing device 50, in this embodiment the video application component is Lync™ 2010 provided by Microsoft Corporation and the interactive board application component is provided by SMART Technologies ULC.

In the case of computing device 50, as the computing device does not comprise an interactive board, the host conferencing application does not comprise an interactive board application component. The host conferencing application does however comprise a video application component that handles the video stream generated in response to video captured by the video camera 54 and that handles incoming video streams generated in response to video captured by the video cameras 36 and 76, an audio application component that handles audio picked up by the microphone 58 and that handles incoming audio streams generated in response to audio picked up by the microphones 32 and 72, and a data conferencing application component that transmits and receives data such as images and annotations to be displayed on the interactive boards 40 and 80 and the display screen 52.

When a conference session is established between the local site 22 and the remote sites 24 and 26, the host conferencing applications running on the computing devices 30, 50 and 70 allow audio, video and data to be shared between the local and remote sites. As mentioned previously, in the case of local site 22, the video camera 36 is positioned and oriented to capture video that includes the participant 44 when the participant is positioned proximate the interactive board 40. The microphone 34 is positioned to capture audio in the local site 22 and the speakers 38 are positioned to broadcast audio received from remote sites 24 and/or 26. The interactive surface 42 of the interactive board 40 presents an image that is shared with the remote sites 24 and 26 for display on the display screen 52 of the computing device 50 and on the interactive surface 82 of the interactive board 80. The image may be for example a computer desktop comprising icons representing selectable application programs and files, one or more windows relating to selected application programs, annotations input by participant 44 interacting with the interactive surface 42 of the interactive board 40, annotations input by participant 84 interacting with the interactive surface 82 of the interactive board 80, video captured by the video cameras 54 and 76 and/or other data received from the computing devices 50 and 70.

In the case of remote site 24, the video camera 54 captures video of the participant 62 positioned proximate the computing device 50. The microphone 58 captures audio output by the participant 62 and the speakers 60 of the headset 56 broadcast audio received from local site 22 and remote site 26. The display screen 52 of the computing device 50 presents the shared image that may include annotations input by the participant 44 interacting with the interactive surface 42 of the interactive board 40 and/or by the participant 84 interacting with the interactive surface 82 of the interactive board 80 or other data input by the participants 44, 62 and 84.

In the case of remote site 26, the video camera 76 is positioned to capture video that includes the participants 86 sitting around the conference table 88. The microphone 72 is positioned to capture audio in the remote site 26 and the speakers 78 are positioned to broadcast audio received from local site 22 and remote site 24. The interactive board 80 presents the shared image that may include annotations input by participant 44 interacting with the interactive surface 42 of the interactive board 40, annotations input by participant 84 interacting with the interactive surface 82 of the interactive board 80, video captured by the video cameras 36, 54 and 76 and/or other data from the computing devices 30, 50 and 70.

Although not described, it will be appreciated that participants of the conference session typically must be verified before being permitted to join the conference session. In many instances, this is achieved by requiring participants to enter a valid conference session password. Alternatives are however possible. In embodiments, participants wishing to join the conference session may be verified by other conference session participants. For example, Bridgit™ conferencing software offered by SMART Technologies ULC of Calgary, Alberta, Canada includes a knock-to-join feature that allows a participant to “knock” on an established conference session. In this case, existing participants of the conference session can decide if the participant is permitted to join the conference session based on the participant's name and a short message.

As mentioned above, the host conferencing application running on the computing device 30 comprises a video interface application component that allows video streams to be presented on the interactive surface 42 of the interactive board 40 in a context sensitive manner. Various embodiments of the video interface application component will now be described.

In one embodiment, the video interface application component running on the computing device 30 processes video streams handled by the video application component prior to display of the video stream on the interactive surface 42 of the interactive board 40 to separate the video stream from its default native presentation interface allowing the separated video stream to be further processed and presented on the interactive surface 42 of the interactive board 40 in a manner customized for the interactive board. The video interface application component may be configured to process video streams received from the remote sites 24 and 26 and/or video streams generated in response to video captured by the video camera 36 at the local site 22.

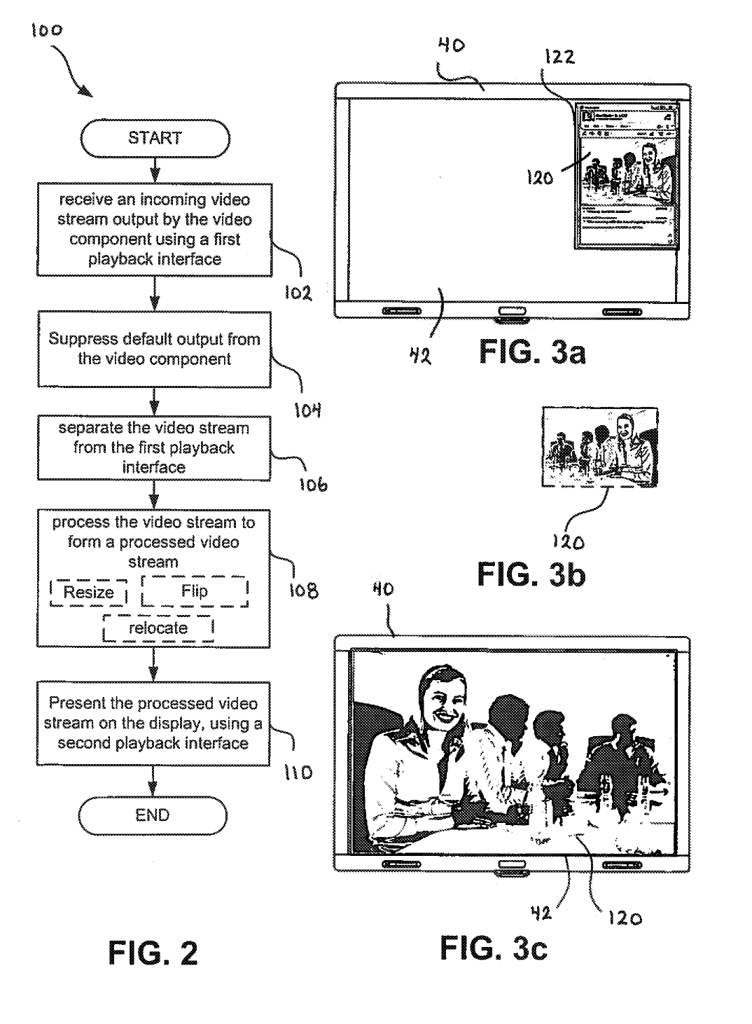

In the following example with reference to FIGS. 2 and 3a to 3c, the video interface application component is configured to process video streams received from remote sites 24 and 26. During a conference session, when the video camera 76 captures video, the captured video is handled by the video application component of the host conferencing application running on computing device 70 and is transmitted to the local and remote sites 22 and 24 over the network 28. When the video stream is received at the local site 22, the video stream is handled by the video application component of the host conferencing application running on the computing device 30. Similarly, when the video camera 54 captures video, the captured video is handled by the video application component of the host conferencing application running on the computing device 50 and is transmitted to the local and remote sites 22 and 26 over the network 28. When the video stream is received at the local site 22, the video stream is handled by the video application component of the host conferencing application running on the computing device 30. When one or both of the incoming video streams are selected for presentation on the interactive surface 42 of the interactive board 40, each selected video stream is processed by the video interface application component before being passed to the interactive board component for display on the interactive surface 42 of the interactive board 40. In this example, as the host conferencing applications running on the computing devices 50 and 70 do not include the video interface application component, when these computing devices receive incoming video streams, the video streams are handled by the video application components in a conventional manner. Accordingly, the handling of these video streams will not be further described.

For ease of discussion, in the following example, it will be assumed that the video stream received from remote site 26 has been selected for presentation on the interactive surface 42 of interactive board 40 and is processed by the video interface application component before being passed to the interactive board component for display on the interactive surface 42 of the interactive board 40. Turning now to FIG. 2, a flowchart 100 of the steps performed when the incoming video stream from remote site 26 is received by the computing device 30. As mentioned above, as the video application component of the host conferencing application running on the computing device 70 is Lync™ 2010, the video stream received by the computing device 30 includes a default native presentation interface. When the video application component of the host conferencing application running on the computing device 30 receives the incoming video stream (step 102), the video application component decodes the incoming video stream. The video interface application component however, suppresses the default output of the video application component (step 104) inhibiting the decoded video stream from being displayed on the interactive surface 42 of the interactive board 40 in its received format. The video interface application component also separates decoded video frames of the video stream from the default native presentation interface of the video stream (step 106) by bit-splitting, that is by copying only the pixels of the decoded video frames and not the portions of the video stream representing window GUI or borders. The separated decoded video frames are then processed (step 108). In this exemplary embodiment, the processing comprises resizing the decoded video frames, flipping the decoded video frames along the vertical axis and relocating the display location of the decoded video frames. The video interface application component then outputs the processed decoded video frames to the interactive board application component allowing the interactive board application component to present the processed video stream on the interactive surface 42 of the interactive board 40 in a manner better suited for the interactive board 40 (step 110).

FIG. 3a shows the incoming video stream 120 from remote site 26 received by the computing device 30, displayed on the interactive surface 42 of the interactive board 40 within its default native presentation interface 122. FIG. 3b shows the incoming video stream 120 after being separated from its default native presentation interface 122 at step 106. FIG. 3c shows the video stream 120 displayed on the interactive surface 42 of the interactive board 40 after processing at step 108. As can be seen, in this example the interactive board application component presents the video stream without borders, and the frames of the video stream have been flipped, maximized and centered to fill the entire interactive surface 42. It will of course be appreciated that the video stream may be presented on the interactive surface 42 of the interactive board 40 within a smaller window that is centered or positioned at an alternative location on the interactive surface 42 or within a designated video area of an alternative presentation interface provided by the interactive board application component. The alternative presentation interface in which the video stream 120 is presented may comprise GUI elements such as selectable control elements to allow the display of the video stream 120 on the interactive surface 42 to be altered. It will also be appreciated that the video stream may be further processed or processed in a different manner. For example, during processing at step 108, the frame rate of the video stream may be changed and/or the frames of the video stream may be interpolated, sub-sampled, flipped along one or more other axes, perspective foreshortened, translated and/or rotated.

Although not described, those of skill in the art will appreciate that when the incoming video stream received by the computing device 30 from the computing device 50 is selected for presentation on the interactive surface 42 of the interactive board 40, the video stream is processed by the video interface application component in a similar manner.

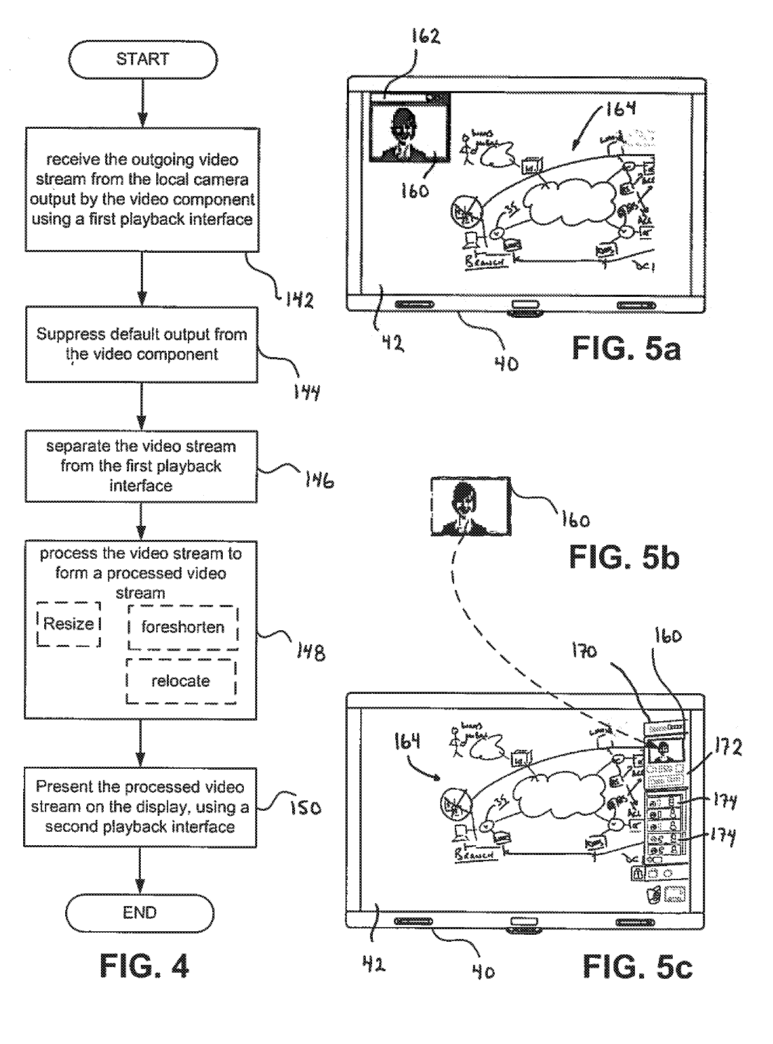

In another example with reference to FIGS. 4 and 5a to 5c, the video interface application component is configured to process the video stream generated in response to video captured by the video camera 36 prior to presentation of the video stream on the interactive surface 42 of the interactive board 40. When the video camera 36 captures video within the local site 22, the resultant video stream handled by the video application component of the host conferencing application is processed by the video interface application component before being passed to the interactive board application component for display on the interactive surface 42 of the interactive board 40.

Turning now to FIG. 4, when the video application component handles the video stream generated in response to video captured by the video camera 36 (step 142), the video application component decodes the video stream. The video interface application component suppresses the default output of the video application component (step 144) inhibiting the decoded video stream from being displayed on the interactive surface 42 of the interactive board 40 in its received format. The video interface application component also separates decoded video frames of the video stream from its default native presentation interface (step 146) by bit-splitting, that is by copying only the pixels of the decoded video frames and not the portions of the video stream representing window GUI or borders. The separated decoded video frames are then processed (step 148). In the exemplary embodiment, the processing comprises resizing the decoded video frames, perspective foreshortening the decoded video frames and relocating the decoded video frames. The video interface application component then outputs the processed decoded video frames to the interactive board application component allowing the interactive board application component to present the processed video stream on the interactive surface 42 of the interactive board 40 in a manner better suited for the interactive board 40 (step 150).

FIG. 5a shows the video stream 160 handled by the video application component that has been generated in response to video captured by the video camera 36, displayed on the interactive surface 42 of the interactive board 40 within its default native presentation interface 162 together with annotations 164. FIG. 5b shows the video stream 160 after being separated from its default native presentation interface 162 at step 146. FIG. 5c shows the video stream 160 displayed on the interactive surface 42 of interactive board 40 after processing at step 148 within an alternative presentation interface 170 provided by the interactive board application component. As can be seen, in this example the presentation interface 170 is at a different location on the interactive surface 42 than the default native presentation interface 162 and comprises a tool bar 172 with selectable control elements to allow the display of the video stream 160 on the interactive surface 42 to be altered. The presentation interface 170 also comprises icons 174 representing other participants of the conference session. Again, it will be appreciated that the video stream 160 may be further processed or processed in a different manner. For example, during processing at step 148 the frame rate of the video stream may be changed and/or the frames of the video stream may be interpolated, sub-sampled, flipped along one or more axes, translated and/or rotated.

In the above examples, the host conferencing application running on the computing device 30 is described as being conditioned to present only one video stream on the interactive surface 42 of the interactive board 40 (the incoming video stream received from remote site 26 in the case of FIGS. 2 and 3a to 3c and the video captured by the video camera 36 in the case of FIGS. 4 and 5a to 5c). As mentioned above however, the host conferencing application running on the computing device 30 may be conditioned to present simultaneously multiple video streams on the interactive surface 42 of the interactive board 40. For example, the host conferencing application running on the computing device 30 may be conditioned to present the incoming video streams received from both remote sites 24 and 26 simultaneously on the interactive surface 42 of the interactive board 40 or to present the incoming video stream received from one or more of the remote sites 24 and 26 as well as the video stream generated in response to video captured by the video camera 36 simultaneously on the interactive surface 42 of the interactive board 40. In the following examples, the host conferencing application running on the computing device 30 will assumed to be conditioned to present simultaneously the incoming video streams received from both remote sites 24 and 26 as well as the video stream generated in response to video captured by the video camera 36 on the interactive surface 42 of the interactive board 40.

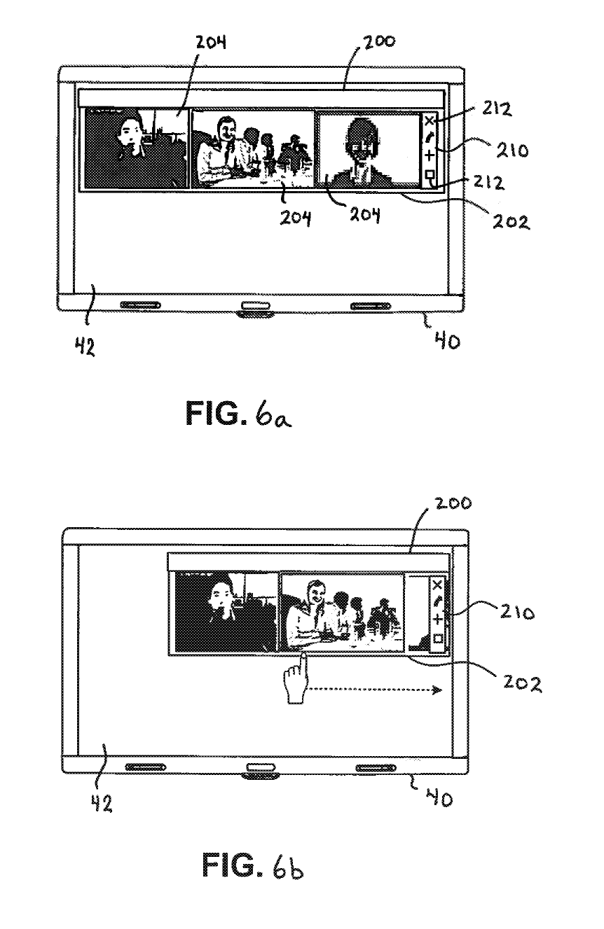

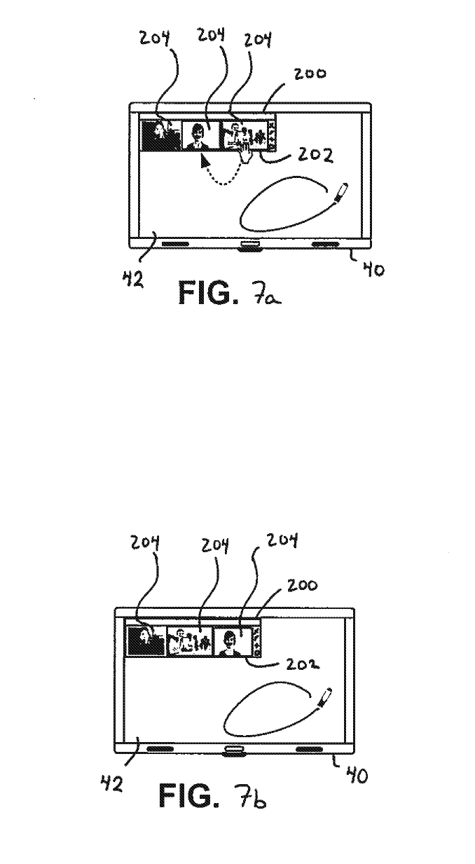

In the example shown in FIGS. 6a and 6b, after the video streams have been processed as described above to separate the video streams from their native default presentation interfaces and have been handed off to the interactive board application component, the video streams are presented in a horizontal video strip 202 within a presentation interface 200, with each video stream being presented in an individual panel or pane 204 of the video strip 202. A tool bar 210 comprising selectable control elements 212 extends along the right edge of the presentation interface 200. The selectable control elements 212 of the tool bar 210 correspond with commands such as removing a video stream from the video strip 202, changing the transparency of the presentation interface 200 etc. The tool bar 210 in this example is docked to the right edge of the interactive surface 42. As result, when the participant 44 interacts with the presentation interface 200 displayed on the interactive surface 42, the location of the tool bar 210 remains fixed. For example, FIG. 6b shows the participant interacting with the presentation interface 200 by performing a swiping action to the right on the video strip 202 that causes the video strip 202 to translate to the right. In this case, the rightmost panel 204 of the video strip 202 moves out of the display range of the interactive surface 42 but the position of the tool bar 210 remains fixed. Those of skill in the art will appreciate that the tool bar 210 does not need to be positioned along the right edge of the presentation interface 200 and does not need to be docked to the right edge of the interactive surface 42. The tool bar 210 can of course extend along a different edge of the presentation interface 200 and be docked to a different edge of the interactive surface 42. Alternatively, the tool bar 210 can be undocked so that the tool bar 210 moves with the presentation interface when the presentation interface is manipulated.

The order in which the video streams are presented within the panels 204 of the video strip 202 may be altered as shown in FIGS. 7a and 7b by selecting one of the panels 204 via pointer interaction with the interactive surface 42 of the interactive board 40 (FIG. 7a) and dragging and dropping the selected video strip panel 204 to its new location in the row of panels (FIG. 7b).

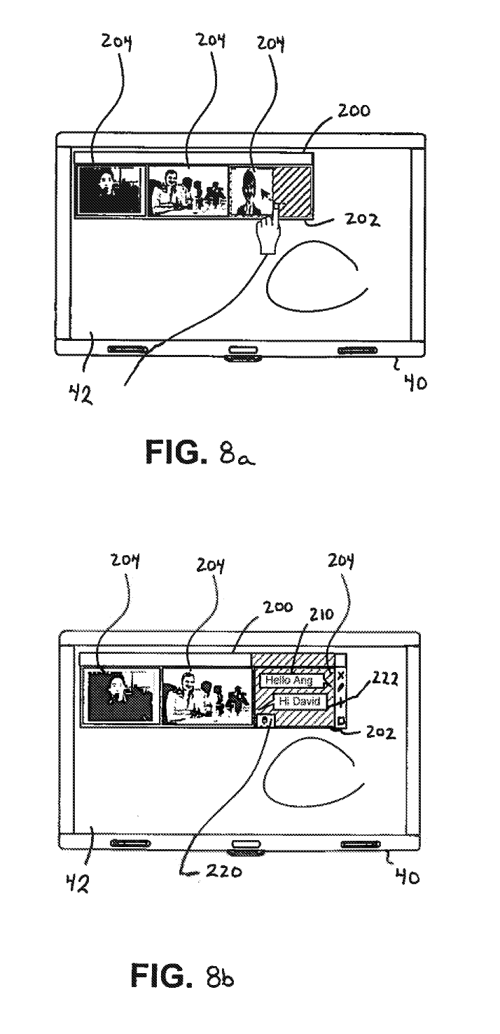

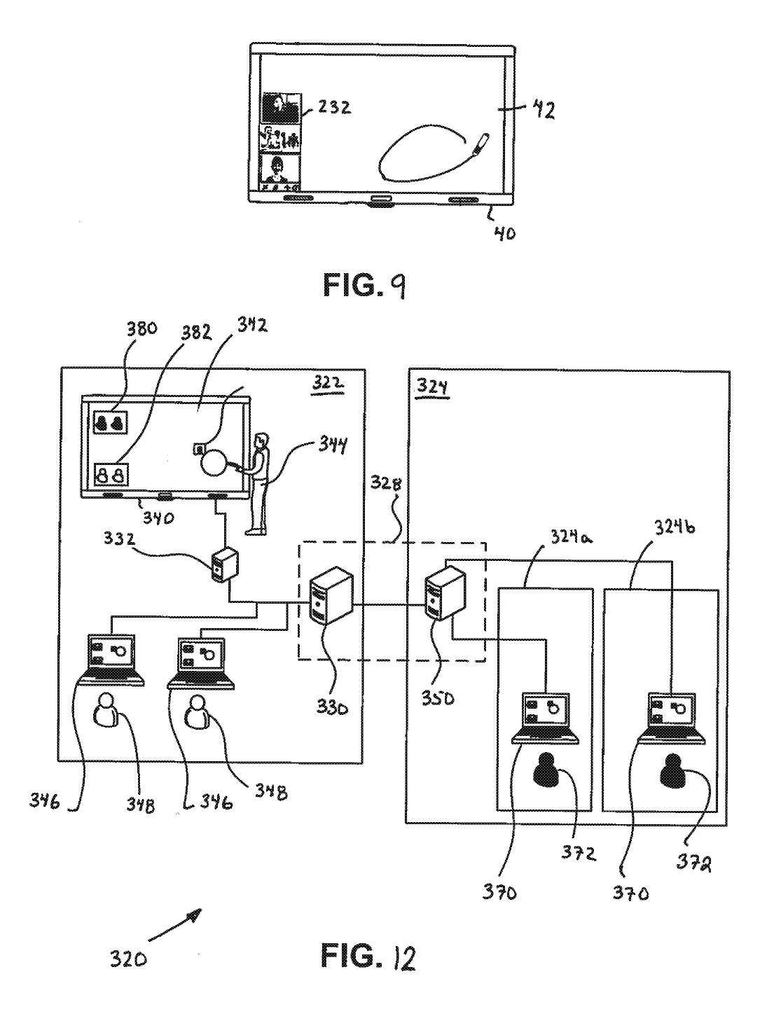

The participant 44 may also initiate a private chat session with one of the remote sites 24 or 26 by performing a flip or other suitable gesture or action on the panel 204 of the video strip 202 that presents the incoming video stream from the remote site as shown in FIGS. 8a and 8b. In this example, a flip gesture is performed on the incoming video stream received from remote site 24 that is presented in the rightmost panel 204 of the video strip 202 (FIG. 8a). In response, the incoming video stream is minimized 220 within the video strip panel 204 and incoming and outgoing chat boxes 222 are opened. The video streams presented in the other video strip panels 204 are unaffected. If desired, when a private chat session is initiated, rather than altering the video strip panel display, a separate window for the private chat session may be opened.

Although FIGS. 6 to 9b show the video strip 202 in a horizontal orientation, those of skill in the art will appreciate that the incoming video streams may be presented in alternative arrangements. For example, FIG. 9 shows the video streams received from remote sites 24 and 26 and the video stream generated in response to video captured by video camera 36 presented on the interactive surface 42 of the interactive board 40 in panels of a vertical video strip 232 adjacent the left edge of the interactive surface 42.

Rather than presenting the video streams in individual panels of a video strip within a single presentation interface, the video streams may be presented within individual presentation interfaces arranged in a row, a column or other desired arrangement. In this case, if the local site 22 comprises more than one interactive board, presentation of the video streams may be distributed across the interactive boards.

When multiple video streams are being presented on the interactive surface 42 of the interactive board 40, the presentation interface may be adjusted to enhance the experience for the participant 44. For example, when an incoming audio stream is received from a remote site, the visual appearance of the incoming video stream from that remote site may be altered, such as by highlighting and/or enlarging the video strip panel or individual presentation interface presenting the video stream. Alternatively or in conjunction, when incoming data is received from a remote site, the visual appearance of the incoming video stream from that remote site may be altered such as by highlighting and/or enlarging the video strip panel or individual presentation interface presenting the video stream. Alternatively, the video stream generated in response to video captured by the video camera 36 may be processed to determine where on the interactive surface 42 the participant 44 is looking and if it is determined that the participant 44 is looking at a particular video stream, the visual appearance of that video stream may be altered such as by highlighting and/or enlarging the video strip panel or individual presentation interface presenting the video stream.

Depending on the setup of the remote sites 24 and 26 generating the video streams, the aspect ratios of the video streams may be different. To deal with this situation, during processing at step 108, the aspect ratios of the incoming video streams are examined to determine if they are different from the default aspect ratio of local site 22. For incoming video streams having aspect ratios different than the default aspect ratio, the aspect ratios of the video streams are adjusted to the default aspect ratio allowing each of the decoded video streams to be displayed on the interactive surface 42 of the interactive board 40 in a consistent manner.

As will be appreciated, adjusting the aspect ratios of the video streams prior to presentation on the interactive surface 42 of the interactive board 40 avoids black bars, white spaces, or frame lines, that typically result from mismatched of aspect ratios, from being displayed.

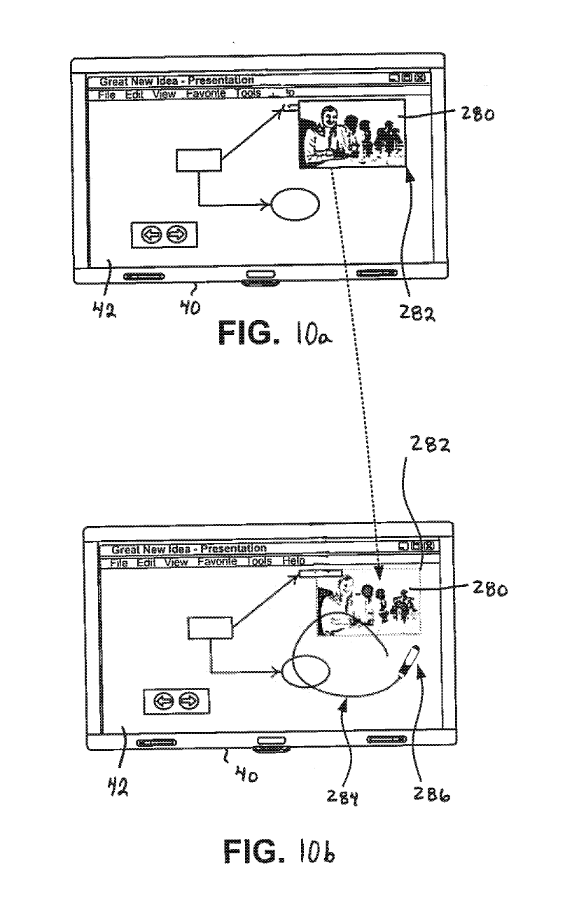

The presentation of the video streams on the interactive surface 42 of the interactive board 40 may be modified in response to participant interaction with the interactive board 40 and/or participant proximity to the interactive surface 42 of the interactive board 40. In the example shown in FIGS. 10a and 10b, participant interaction with the interactive surface 42 of the interactive board 40 is used to alter the appearance of the video stream 280 presented on the interactive surface 42 of the interactive board. FIG. 10a shows the interactive board 40 with the incoming video stream 280 received from remote site 26 presented within a presentation interface 282 adjacent the top right corner of the interactive surface 42. During processing of the decoded video frames at step 108, when the participant 44 interacts with the interactive surface 42, in this case by inputting annotations 284 using a pen tool 286, transparency of the presentation interface 282 and video stream 280 is increased to highlight the visibility of the input annotations 284 as shown in FIG. 10b.

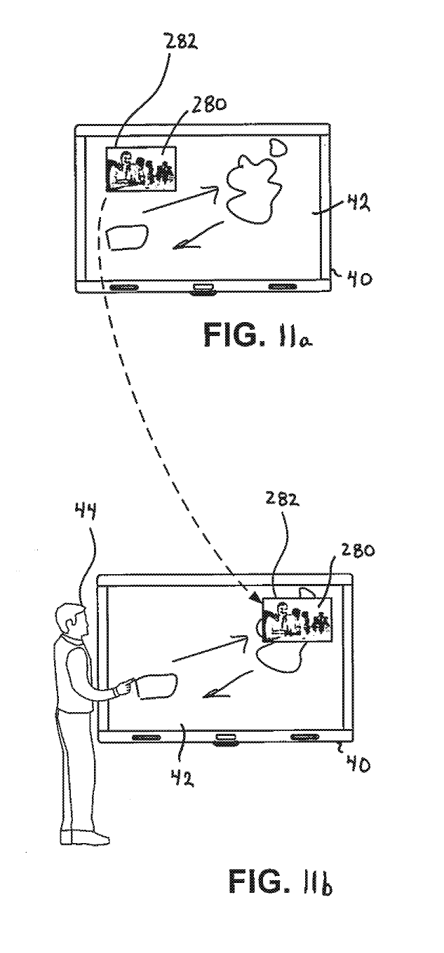

In another example, the interactive board 40 may comprise one or more proximity detectors about the periphery of the interactive surface 42 for detecting the presence of the participant 44. The output of the proximity detectors may be used to alter the location at which the processed decoded video stream(s) is(are) presented on the interactive surface 42 of the interactive board 40. FIG. 11a shows the interactive board 40 equipped with at least one proximity detector (not shown). In this example, the incoming video stream 280 received from remote site 26 is presented within a presentation interface 282 adjacent the top left corner of the interactive surface 42 of the interactive board 40. During processing of the decoded video frames at step 108, when the participant 44 approaches the interactive board 40 and is detected by the proximity detector, the detected position of the participant 44 is used to move the presentation interface 282 to a different location on the interactive surface 42 away from the participant 44, in this case adjacent the top right corner of the interactive surface 42 as shown in FIG. 11b.

In another embodiment, the video stream associated with the participant is used to verify the user's identify. The participant wishing to join the conference is required to submit their associated video stream so the participants already in the conference can verify the participant's identify before allowing the participant to join the conference. This provides enhanced security as the participant's identity can be positively identified.

If desired, the video streams may be grouped according to, for example, geographic location, departmental membership in an organization, membership in other groups, or social groups or on the basis of data or meta-data associated with the video streams as will now be described.

Turning now to FIG. 12, an alternative conferencing system is shown and is generally identified by reference numeral 320. In this embodiment, the conferencing system 320 comprises a plurality of conference sites or participant locations, namely a local site 322 and a remote site 324 that communicate with each other over a network 328 during a conference session. The network 328 may be for example a local area network (LAN) or Intranet within an organization, a wide area network (WAN), a cellular network, the Internet or a combination of different networks. Although only one remote site 324 is shown, those of skill in the art will appreciate that this is for ease of illustration only. During the conference session, multiple remote sites 324 may communicate with the local site 322 over the network 328.

In this embodiment, local site 322 comprises a computing device 330 such as a server that communicates with the network 328 over a suitable wired, wireless or combined wired/wireless connection. The computing device 330 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.) and a system bus coupling the various components to the processing unit. A plurality of external peripheral devices are connected to the computing device 330 via suitable wired or wireless connections. In particular, a microphone (not shown), a video camera (not shown), speakers (not shown), and a computing device 332 are connected to the computing device. An interactive board (IB) 340 having an interactive surface 342 on which images are displayed is connected to the computing device 332. A participant or conferee 344 is shown standing in front of the interactive surface 342 of the interactive board 40. Computing devices 346 are also connected to the computing device 330 via suitable wired or wireless connections. In this embodiment, the computing devices 346 are in the form of laptop computers with each computing device having an integrated display screen, video camera (not shown), microphone (not shown) and speakers (not shown). Each computing device 332 and 346 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.), input/output devices (e.g. a mouse, a keyboard, one or more buttons etc.), and a system bus coupling the various components to the processing unit. A participant 348 is associated with each computing device 346.

Remote site 324 comprises a computing device 350 such as a server that communicates with the network 328 over a suitable wired, wireless or combined wired/wireless connection. The computing device 350 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.) and a system bus coupling the various components to the processing unit. Computing devices 370 are also connected to the computing device 350 via suitable wired or wireless connections. In this embodiment, the computing devices 370 are in the form of laptop computers at different geographic locations 324a and 324b within the remote site 324 such as separate rooms, with each computing device having an integrated display screen, video camera (not shown), microphone (not shown) and speakers (not shown). Each computing device 370 comprises, for example, a processing unit comprising one or more processors, system memory (volatile and/or non-volatile memory), other non-removable memory and/or optional removable memory (e.g. a hard disk drive, RAM, ROM, EEPROM, CD-ROM, DVD, flash memory, etc.), input/output devices (e.g. a mouse, a keyboard, one or more buttons etc.), and a system bus coupling the various components to the processing unit. A participant 372 is associated with each computing device 370.

The computing devices 330 and 350, similar to the previous embodiment, run a host conferencing application allowing the computing devices 332, 346 and 370 to share audio, video and data during a conference session. The host conferencing application running on the computing device 330 comprises a video interface application component that allows video streams to be presented on the interactive surface 342 of the interactive board 340 in a context sensitive manner. In this embodiment, the video interface application identifies the geographic location of video streams handled by the video application component of the host conferencing application and uses this information to tailor the display of the video streams on the interactive surface 342 of the interactive board 340. In particular, the video interface application component uses the IP addresses of the computing devices 330 and 350 handling video streams to group the video streams during presentation. In the example shown in FIG. 12, video streams handled by the video application component of the host conferencing application running on computing device 330 are presented on the interactive surface 342 of interactive board 340 in two presentation interfaces 380 and 382, respectively. The presentation interface 380 presents the video streams received from computing devices 370 while the presentation interface 382 presents the video streams received from computing devices 346.

Although in the above embodiment, the video streams are grouped using IP addresses, those of skill in the art will appreciate that alternatives are possible. For example. the video streams may be grouped based on the IP addresses of the computing devices and the subnet mask. Alternatively, the video streams may be grouped based on network latency associated with the transmission and reception of the video streams. Video streams received with similar latency times may be grouped together on the presumption that the video streams are being transmitted from similar geographic locations. The video streams may be grouped based on data from identity registration services used by software as a service (SaaS) architectures. In this case, as participants of the conference session have logged on to their accounts on the registration service, the participant account information can be used to group video streams. For example, video streams can be grouped according to e-mail addresses, physical locations, membership in a department, access levels, and/or phone numbers. Alternatively, the video streams may grouped based on information from an external identity server, e.g. Microsoft™ Active Directory that organizes participants into teams. Data from, for example, the Microsoft™ Active Directory is cross-referenced with usernames and e-mail addresses to uniquely identify and group participants. Other data sources can be used as well such as Google™, Windows Live™, and Facebook™.

If desired, preference data associated with one or more participants may be stored in a database that is used to determine the manner in which video streams are presented. In this case, when a user logs in to the conferencing session, the preference data for the participant is retrieved from the database if it exists and is used by the interactive board application component to control the display of video streams for that participant.

In another embodiment, when a participant shares data with other participants during a conference session, an avatar, i.e. a graphical image or video representing the participant may be associated with the shared data. When the shared data is displayed, a window displaying the avatar may also be presented. In another embodiment, the avatar may be used to tag data shared by the participant. In this manner, when participants select the shared data, the avatar is presented.

In the examples above, although only the host conferencing application running on the local sites 22 and 322 has been described as comprising the video interface application component, those of skill in the art will appreciate that the video interface application component may be included in the host conferencing application of one or more of the remote sites. The video interface application component can be incorporated into basically any computing environment where it is desired to strip the default native presentation interface from a video stream so that the video stream can be presented on a display in a different format that is suited for the display.

Those skilled in the art will appreciate that the host conferencing application described above may comprise program modules including routines, object components, data structures, and the like, embodied as computer readable program code stored on a non-transitory computer readable medium. The non-transitory computer readable medium is any data storage device that can store data. Examples of non-transitory computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion.

Although computing devices in the form of laptop computers have been described above, those of skill in the art will appreciate that the computing devices may take a variety of forms, such as for example, personal computers, tablet computers, computerized kiosks, personal digital assistants (PDAs), cellular phones, smartphones, etc. Also, although the interactive boards have been described as employing analog resistive or machine vision technology to detect pointer interaction with the interactive surfaces, those of skill in the art will appreciate that other technologies to detect pointer interaction may be employed such as acoustic, electromagnetic, capacitive and FTIR technologies. Display devices such as flat panel, liquid crystal and light emitting diode displays or other such devices having interactive surfaces may also be employed.

Although the local site 22 and the remote site 26 are described as including external peripherals in the form of a microphone, a video camera and speakers and the remote site 24 is described as comprising an external peripheral in the form of a headset, those of skill in the art will appreciate that alternatives are available. The sites may comprise multiple external peripherals of the same type (e.g. multiple microphones, multiple video cameras etc.), a subset of the described external peripherals and/or alternative external peripherals.

In instances where video application components provide video streams separately from the their default native default presentation interfaces, it will be appreciated that the video interface application component is not required to strip the default native presentation interfaces from the video streams. In this case, the video interface application component simply passes the incoming video streams to the interactive board application components for handling.

Although embodiments have been described above with reference to the accompanying drawings, those of skill in the art will appreciate that variations and modifications may be made without departing from the scope thereof as defined by the appended claims.

What is claimed is:

1. A method comprising:
receiving, by a computing device, a video stream comprising a first presentation interface;
separating the received video stream from the first presentation interface;
processing the separated video stream; and
presenting the processed video stream on a display device in the absence of said first presentation interface.

2. The method of claim 1 wherein said presenting comprises presenting the video stream on the display device within a second presentation interface.

3. The method of claim 2 wherein the first presentation interface is the default native presentation interface of a video application component generating the video stream.

4. The method of claim 3 wherein the display device comprises an interactive surface.

5. The method of claim 4 wherein the second presentation interface is customized for said interactive surface.

6. The method of claim 4 further comprising altering the appearance of the video stream presented within said second presentation interface.

7. The method of claim 6 wherein said altering comprises changing the transparency of the video stream and second presentation interface.

8. The method of claim 7 wherein said altering is performed in response to one of selection of a graphical interface control element displayed on said interactive surface or annotation input made on said interactive surface.

9. The method of claim 6 wherein said altering comprises changing the position of the video stream presented within said second presentation interface.

10. The method of claim 9 wherein said changing is performed in response to detection of a user in proximity to said interactive surface.

11. The method of claim 1 wherein processing the separated video stream comprises at least one of rotating frames of said video stream, resizing frames of said video stream, bit-splitting frames of said video stream, interpolating frames of said video stream, sub-sampling frames of said video stream, flipping frames of said video stream, perspective foreshortening frames of said video stream, relocating frames of said video stream, and adjusting the frame rate of the video stream.

12. A non-transitory computer readable medium having computer program code stored thereon, the computer program code when executed by one or more processors, causing the one of more processors to:
separate a received video stream from a first presentation interface thereof;
process the separated video stream; and
present the processed video stream on a display device in the absence of said first presentation interface.

13. A method comprising:
receiving, by a computing device, a plurality of video streams, at least one of said video streams comprising a first presentation interface;
separating the at least one video stream from the first presentation interface;
processing the separated at least one video stream; and
presenting the processed at least one video stream on a display device in the absence of said first presentation interface.

14. The method of claim 13 wherein said presenting comprises presenting the at least one video stream on the display device within a second presentation interface.

15. The method of claim 14 wherein the first presentation interface is the default native presentation interface of a video application component generating the at least one video stream.

16. The method of claim 15 wherein the display device comprises an interactive surface.

17. The method of claim 16 wherein said presenting comprises presenting a plurality of said video streams within said second presentation interface.

18. The method of claim 17 wherein said video streams are arranged in one of a horizontal row and a vertical column.

19. The method of claim 18 wherein said video streams are presented within panels or panes of a video strip.

20. An apparatus comprising:
at least one display device;
memory storing executable code; and
one or more processors communicating with said display device and memory, said one or more processors configured to execute said executable code at least to cause said apparatus to:
separate a received video stream from a first presentation interface thereof;
process the separated video stream; and
present the processed video stream on the display device in the absence of said first presentation interface.
